(19) United States
(12) Patent Application Publication
(10) Pub. No.: US 2025/0314277 A1
(43) Pub. Date: Oct. 9, 2025

(54) FRICTION MATERIAL COMPOSITION AND ASSOCIATED FRICTION ELEMENT

(71) Applicant: ITT Italia S.R.L., Milan (IT)

(72) Inventors: Agustin SIN XICOLA, Barge (IT); Flavio TROMBOTTO, Barge (IT); Daniele GENTA, Barge (IT)

(73) Assignee: ITT Italia S.R.L., Milan (IT)

(21) Appl. No.: 18/872,578

(22) PCT Filed: Jun. 20, 2023
(86) PCT No.: PCT/IB2023/056366

§ 371 Date: Dec. 6, 2024

(30) Foreign Application Priority Data
Jun. 20, 2022 (IT) 102022000013012

(51) Int. Cl. F16D 69/02

(52) U.S. Cl. CPC F16D 69/026; F16D 2200/0069

(57) ABSTRACT

An asbestos free friction material composition and associated brake pad for vehicles, in particular for electric vehicles, having an improved friction stability, a reduced creep groan noise propensity and a lower particles emission, wherein the composition comprises at least one filler, at least a fibrous material, at least one binder, at least one lubricant, at least one or more abrasives, at least a first carbonaceous material having a particle size distribution such as to have a D₅₀ higher than 10 μm and at least a second carbonaceous material having a particle size distribution such as to have a D₅₀ less than 10 μm.

### CROSS-REFERENCE TO RELATED APPLICATIONS

This Patent Application claims priority from Italian Patent Application No. 102022000013012 filed on Jun. 20, 2022, the entire disclosure of which is incorporated herein by reference.

### TECHNICAL FIELD

The present invention relates to friction material composition particularly suitable for the manufacture of friction layers/blocks for friction elements such as braking elements to be incorporated, for example, in a vehicle braking system.

The invention also relates to an associated fiction element, for example brake pads or brake shoes for vehicles, made with this friction material composition and particularly but not exclusively suitable for electric vehicle.

The friction material composition of the present invention is free of asbestos, belonging to the so-called NAO (“Non Asbestos Organic”) type, and is, particularly but not exclusively, free of Copper.

### STATE OF THE ART

With the rapid development of modern transportation industry, the number of electric vehicles is increasing day by day.

The replacement of combustion engine with an electrical one leads to much more silent vehicles, This is bearing higher attention to those noises generated by other car components, such as by the brake pad embedded in the braking system. Consequently, the bake pad used for electrical vehicles requires improved NVH (Noise, Vibration, Harshness) criterion for driving comfort, while keeping and, in some instance, improving braking performances in terms of friction stability, stiction and corrosion cleanability.

In parallel, the trend of the future mobility pays particular attention for environment and health hazard issues, aiming to decrease the emission of particulate matter (PM10 and PM2.5) generated, for example, by the breaking system.

In regards to the operating noise of the braking system, it is known that this phenomenon has a complex and multi-factorial origin and depends both on the driving vibration of the vehicle associated with the inevitable assembly clearances between braking elements, such as brake pads and shoes and the respective supports, and from the contact phenomena occurring between the sliding part of the braking elements and the supports, during the actuation of the braking system.

This contact phenomenon is known as “Creep groan” and it results in an annoying high-intensity and low frequency noise at very low speeds of the vehicle. It is the classic. example of a self-excited braking vibration caused by the so-called “Stick-Slip” effect, i.e. by alternated episodes of sticking or adhesion and subsequent slipping of the brake pad on the brake disc during the braking process and a result the coefficient of friction continuously varies between a static (stick phase) and dynamic (slip phase) values.

On modern vehicles, such as electric vehicles, the need to eliminate or at least reduce low frequency noise in a simple and above all economic way is strongly felt.

Indeed, regarding the electric vehicles, they are far quieter than their internal combustion engine counterparts. Especially, unlike engine drive vehicles, the electric vehicles quietly start moving due to the electric motor. Hence, the driver and passenger are more likely to feel the noises as described above and possibly make them feel uncomfortable. Moreover, these type of noises may affect the living environment of residents and may become a new noise pollution source in cities.

Various solutions are known in the art to try to reduce this phenomenon, but they either do not solve completely the problem or present additional drawbacks.

EP0959262 discloses a disc brake pad capable of reducing creep groan using a composition containing a fibrous base material, except asbestos, a binder and a friction regulating agent, wherein the binder consists wholly or partially of a modified silicone resin and wherein, in combination, the friction material composition contains between 0.5 and 20% by volume of a zeolite as part of the agent regulating friction, the modified silicone resin being contained in the composition of friction material in the amount from 3% to 30% by volume of the total composition. The modified silicone resin is obtained by reacting an oil or a silicone rubber with a phenolic resin of the novolac type. This results in an expensive material and difficult to be produced.

On the other hand, WO2019120648 discloses a hybrid friction lining material and brake pads made therefrom, wherein the positive properties of a steel low friction lining material (so-called Low Steel (LS) friction linings of friction lining material) and an asbestos-free organic friction lining material are attempted to be combined. In preferred embodiments, such hybrid friction material contains: 15 to 22% w (by weight), in particular 17 to 20% w, of at least one binder, 5 to 11% w organic fibers or a mixture of organic fibers, 1 to 20% w, in particular 8 to 14% w, of at least one further organic compound, zero or from 8 to 16% w of inorganic fibers or a mixture of inorganic fibers, 10 to 40% w of at least one inorganic oxide, 6 to 12% w, of at least one inorganic silicate, 13 to 15% w of sulfur or at least one inorganic sulfur compound, 10 to 16% w of carbon or at least one material consisting essentially of carbon, in particular selected from the group consisting of natural graphite, synthetic graphite, petroleum coke, desiccated petroleum coke, carbon black and any mixtures thereof, from 1 to 1.5% w of at least one filler selected from the group of inorganic hydroxides, in particular calcium hydroxide, and zero up to 1% w of at least one metal, in particular iron or iron alloys.

Such hybrid material however gives rise to a behavior which is a compromise in term of braking performances and comfort, which may be not optimal or less than optimal for many applications.

CN106015399 discloses friction material for an electric vehicle brake piece. The friction material comprises, by weight, 25-30 parts of carbon fiber, 10-15 parts of aramid fiber, 40-50 parts of nitrile rubber, 20-30 parts of styrene-butadiene rubber, 10-20 parts of carbon black, 5-12 parts of composite mineral fiber, 1-3 parts of sulfur, 1-4 parts of vermiculite, 2-7 parts of epoxy resin, 6-15 parts of barium sulfate, 3-8 parts of graphite, 0.5-1 parts of an accelerator, 2-4 parts of stabilizer, 1-2 parts of water. However, the brake pad comprising this frictional material does not display any overcoming of the drawbacks in terms of noise and particle emission reduction as well as of improved friction stability.

### SUMMARY OF THE INVENTION

The object of the present invention is to develop a new asbestos free friction material composition, which is capable of overcoming the disadvantages of the prior art and jointly exhibiting improved braking performances, in terms of low frequency noise and friction stability, and reduced particle emission. In particular, the presently disclosed subject matter is intended to provide an asbestos free friction material composition which combines improved creep groan and friction stability, by reducing the tendency of the friction block to stick against a surface of a friction partner cooperating therewith, with reduced particle emission by decreasing material wear and optimizing heat dissipation.

The invention is therefore related to friction material composition as defined in the appended claims.

It is a further object of the invention to provide friction element, in particular a brake pad or brake shoe, including this friction material composition.

Further features and advantages of the disclosed subject matter, whether explicitly mentioned or not, will become apparent in view of the disclosure provided below.

This disclosure therefore relates to a friction material composition, belonging to the class of friction materials known as NAO (Non Asbestos Organic), which aims to obtain an improved stick-slip behavior for the benefit of the creep groan phenomenon and friction stability, as well as to reduce the particle emission, with respect to known. NAO friction compositions.

Indeed, differently to the known NAO friction compositions, the disclosed friction material composition comprises, in combination, at least a first and at least a second carbonaceous material having particle size distribution such s to have a D₅₀ higher than 10 μm and lower than 10 μm, respectively.

Thanks to the combination of the at least first and of the least second carbonaceous material, the disclosed friction material composition leads both to a reduced stick-slip phenomenon, which, in turns, positively affects both the creep groan noise and the friction stability, and to a reduced particle emission, Specifically, the friction element, comprising the disclosed friction material composition, makes the brake system less prone to a stick-slip behavior thanks, mainly, to an optimized porosity of the friction material which improves the adhesion between the friction element and the brake disc as well as it reduces the negative effects of humidity on the friction coefficient.

In parallel, the reduced particle emission results from the synergetic effect of the first carbonaceous material, which reduces the friction between the brake disk and the friction element for the benefit of the friction element wear, and of the second carbonaceous material, which dissipates the heat developed during the. braking application, instead of being accumulated in the friction element destroying the binder

### BRIEF DESCRIPTION OF THE DRAWINGS

Further characteristics and advantages of the present invention will become clear from the following description, from practical and comparative non-limiting examples and with reference to the drawings attached, in which:

FIG. 1 gives the results of the wear tests performed friction elements made of two friction material compositions, one according to the invention, and one made of comparative friction material composition;

FIG. 2 shows the report of the results obtained from AK-Master test for the friction element made of the comparative friction material composition;

FIG. 3 illustrates the report of the results obtained from AK-Master test for the friction element made friction material composition according to the invention;

FIG. 4 shows the results of the creep groan tests for two friction elements made of the friction material composition according to two different embodiments of the invention and one friction element made of the comparative friction material composition;

FIG. 5 illustrates porosity characterization of two friction elements made of the friction material composition according to two different embodiments of the invention and one friction element made of the comparative friction material composition.

### DETAILED DESCRIPTION

In more detail, the disclosed asbestos free friction material composition comprises at least one filler, at least a fibrous material, at least one binder, at least one lubricant, at least a first and at least second carbonaceous material having a particle size distribution such as to have a D₅₀ so higher than 10 μm and lower than 10 μm, respectively, and at least one or more abrasives.

Here and in the following, “particle size distribution D₅₀” corresponds to the value of the particle diameter at 50% in the cumulative distribution.

Preferably, the at least first carbonaceous material having a D₅₀ higher than 10 μm is present in the disclosed composition in an amount ranging from 2 to 6% in weight calculated on the total weight of the friction material composition.

Preferably, the at least second carbonaceous material having a D₅₀ less than 10 μm is present in the disclosed composition in an amount ranging from 1 to 4% in weight calculated on the total weight of the friction material composition. Most preferably, the amount of the at least second carbonaceous component is 2% in weight.

The ratio between the content in weight of the first and the second carbonaceous material may range from 1:1 to 6:1 and preferably from 2:1 to 3:1.

The first carbonaceous material having a D₅₀ higher than 10 μm can be selected from the group consisting of graphite, petroleum coke, desiccated petroleum coke, carbon black and any mixtures thereof. Preferably, the first carbonaceous material having a D₅₀ higher than 10 μm is graphite.

The second carbonaceous material having a D₅₀ less than 10 μm is selected among the fillers consisting in carbon black.

Other than the at least first and the at least second carbonaceous material, the other components of the disclosed friction material composition, above mentioned, can be components used in frictional materials already knows in the art.

In particular, the at least one fibrous material can be selected from the group consisting of inorganic fibers, organic fibers, metallic fibers and any combination thereof.

Preferably, the at least one fibrous material consists in organic fibers selected from the group consisting of polyacrylic fibers, polyaramid fibers, aramid fibers, cellulose fibers and mixtures thereof.

The organic fibers may be, preferably but not exclusively, contained in the friction material composition of the present disclosure as a part of the organic binder, since they may have the main object to increase the strength thereof under the operative working conditions of the brake pads/shoes which may be manufactured from the friction material composition of the present disclosure.

The at least one binder is preferably an organic binder and may be selected from the group consisting of phenolic resins, epoxy resins, siliconic resins, modified phenolic resins, melamminic resins, polymmide resins and mixtures thereof.

The at least one lubricant may consist, preferably but not exclusively, of a sulphide based lubricant selected from the group consisting in metal sulfides of Sn, Zn, Fe, Mo, and mixtures thereof.

Numerous materials can be used as organic or inorganic filler. Preferably, the at least one filler is an inorganic filler selected from the group consisting of mineral fibers, glass fiber, rockwood, phillosilicates (mica, vermiculite, talc, etc.), titanates, inorganic hydroxides of Calcium, Magnesium, Potassium, and any mixture thereof.

The at least one or more abrasives comprise at least one soft abrasive having a Mohs hardness of below 7 and at least one hard abrasive having a Mohs hardness of above 7,

The ratio between the content in weight of the soft 10 abrasive and of the hard abrasive is ranging from 1:1 to 4:1 and may be preferably 2:1.

Hard abrasives (i.e. having a Mohs hardness of above 7) have, preferably but not exclusively, a roundish-shape and are selected, preferably but not exclusively, in the group consisting of zirconia, alumina, corundum, silicon carbide, tungsten carbide, zirconium carbide, zirconium silicate, boron nitride and any mixture thereof.

Soft abrasive (i.e. having a Mohs hardness of below 7) may be selected, preferably but not exclusively, in the group consisting of magnesia, cromite, magnetite, hematite,: quartz, zinc oxides, tin oxides, barium sulphate, silicate, fluoride and any mixture thereof.

According to a preferred embodiment of the present invention, the disclosed friction composition is copper free.

Here and in the following, the expression “copper-free” is to be understood to imply a content of copper and/or of copper containing materials, like copper alloys, of, or lower than, 0.5% by weight.

The at least one metal or a mixtures of metal, when present in the disclosed friction material composition, does not consists of copper and/or any copper alloys, but it is selected from the group consisting of iron, steel, stainless steel, tin, zinc, and any alloy thereof in powder or fiber form.

In addition, the disclosed friction material composition may comprise organic additives selected from the group consisting of polytetrafluoroethylene, friction dust, cashew dust, rubbers (i.e. NBR, siliconic, SBR, etc.).

In a further embodiment of the present invention, the disclosed average friction material composition follows (% is in weight):

| | |
|---|---|
| ABRASIVE MOHS > 7 | 15-35% |
| ABRASIVE MOHS < 7 | 30-60% |
| RESIN | 6-10% |
| ORGANIC ADDITIVES | 4-8% |
| ORGANIC FIBER | 2-4% |
| LUBRICANTS | 2-8% |
| FIRST CARBONACEOUS MATERIAL | 2-6% |
| SECOND CARBONACEOUS MATERIAL | 1-4% |

The invention lastly relates also to a friction element, in particular a brake pad or shoe, presenting a layer of friction material made from the friction: material composition described above.

The invention further relates a braking system comprising a member to be braked, constituted by a brake disc or brake drum made of cast iron or steel and at least one braking element constituted by a brake pad or shoe which is designed to cooperate by means of friction with the member to be braked, wherein the braking member presents a friction layer which is intended to cooperate with the member to be braked and which is made of the friction material composition described above.

### Exemplary Modes of Carrying Out the Teaching of the Present Disclosure

Inventive and comparative examples are reported here by way of illustration and are not intended to limit the invention.

### EXAMPLE 1

Three formulations were prepared marked as “Bi-Carbon-28”, “Bi-Carbon 4%” and “Mono-Carbon”, according to the following Table 1, The components shown in Table 1 are indicated in percentage values by weight of the total weight of the composition.

The friction material compositions according to the invention are indicated with “Bi-Carbon 2%” and “Bi-Carbon 4%” and they differ based on the second carbonaceous material content.

The comparative friction material composition, indicated with “Mono-Carbon”, has a composition of a standard NAO category and substantially identical to the compositions of the invention, but free of the second carbonaceous material having a D₅₀ less than 10 μm.

TABLE 1

| | “Bi-Carbon | “Bi-Carbon | “Mono- |
|---|---|---|---|
| COMPONENTS | 2%” | 4%” | Carbon” |
| Abrasive Mohs > 7 | 15-35 | 15-35 | 15-35 |
| Abrasive Mohs < 7 | 30-60 | 30-60 | 26-56 |
| Resin | 6-10 | 6-10 | 6-10 |
| Organic additives | 4-8 | 4-8 | 4-8 |
| Organic fiber | 2-4 | 2-4 | 2-4 |
| Lubricants | 2-8 | 2-8 | 2-8 |
| Fist carbonaceous | 2-6 | 2-6 | 2-6 |
| material (D₅₀ > 10 μm) | | | |
| Second carbonaceous | 2 | 4 | |
| material (D₅₀ < 10 μm) | | | |
| TOTAL | 100.00 | 100.00 | 100.00 |

The components shown in Table 1 were uniformly mixed in Horizontal Mixer (e.g. Loedige kind mixer) and molded in a mold under a pressure of 20 tons for 3 minutes at a temperature of 160° C., then cured from 10 minutes to 10 hours at temperature ranging from 150°° C. to 400° C., producing two. friction materials according to the invention, indicated as “Bi-Carbon 2%” and “Bi-Carbon 4%”, and one comparative friction material used for subsequent comparative tests indicated as “Mono-Carbon”; each block of friction material so obtained is made integral with identical metal supports consisting in flat steel plates (back-plates) to form vehicle brake pads.

### EXAMPLE 2

### Wear, Particles Emission and Efficiency Tests

Each brake pad, produced in the manner described in Example 1, has been mounted on a brake caliper with a hydraulic actuator, then it has been connected to a dynamometer and it has undergone the following tests.

The specifications of the used dynamometer a
DC motor 191 KW,
Constant torque of 2000 Nm up to 991 rpm,
Constant power from 911 to 200 rpm,
Drag torque 2000 Nm,
Max pressure: 200 bar,
Max speed: 2600 rpm,
Mechanical inertia up to 50 kg/m²
brake aspiration/ventilation flow rate 1200-2000 m³/h,
4 input analog channels for fixed temperature measurements,
friction level elaboration.

### Wear Test

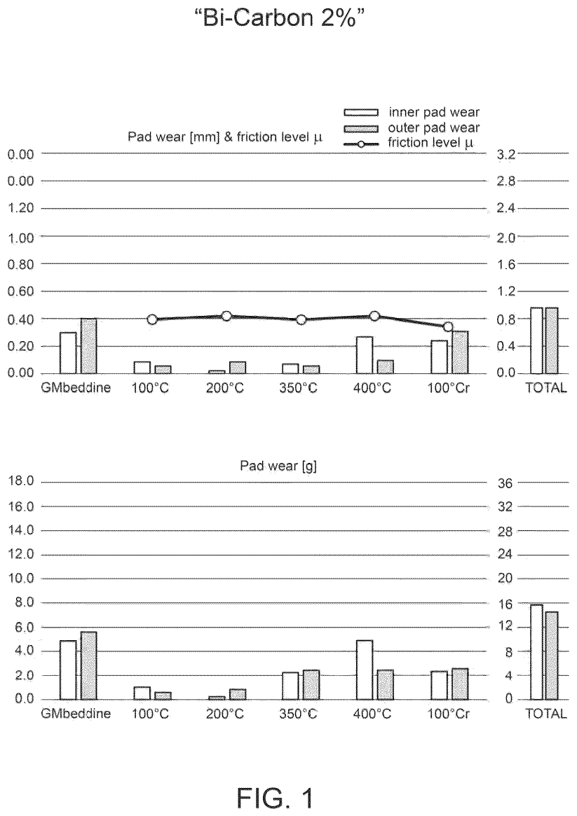

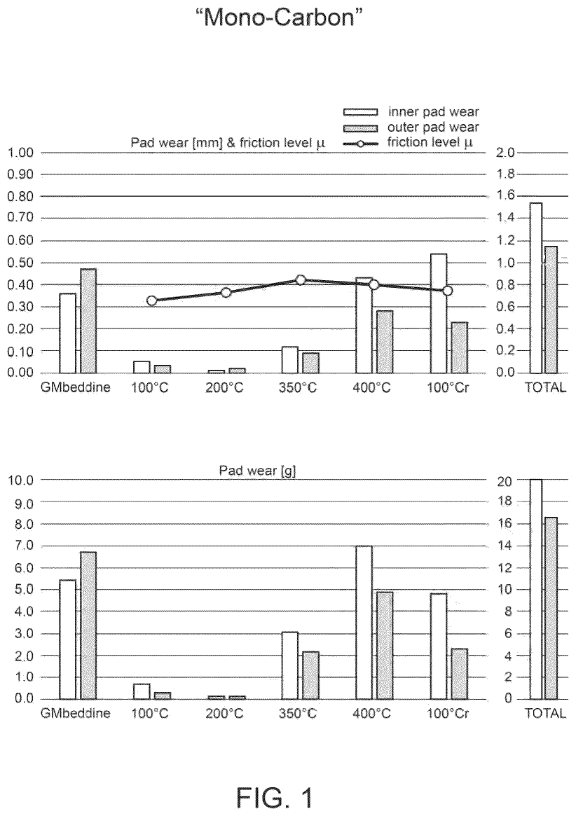

The test results referring to the brake pad containing the friction material composition of the invention, named “Bi-Carbon 2%, and to the brake pad containing the comparative friction material composition, named “Mono-Carbon”, are shown in FIG. 1.

Specifically, the results, depicted on the top part of FIG. 1, refer to the thickness loss (in mm) of the inner and outer brake pads resulting from 1000 braking applications at 100° C., 200 braking at 200° C., 500 braking at 350° C., 400and 1000 braking at 100°° C. (repetition of first cycle). At the same time, the corresponding friction coefficient (μ) is shown.

Comparing the brake pad wear for both test sets, it can be seen that the “Bi-Carbon 2%” brake pad according to the invention shows the lowest thickness loss. This means that the “Bi-Carbon 2%” brake pad has a longer life and thus it incurred less loss material (so also less environment pollution) and maintenance cost than the comparative “Mono-carbon” brake pad.

Notably, also the friction coefficient of the “Bi-Carbon 2%” brake pad is more stable than that of the “Mono-Carbon” brake pad.

A confirmation of the lower wear of the “Bi-Carbon 2%” brake pad is obtained in regards to the amount of mass loss (in grams) as depicted on the bottom part of FIG. 1. Indeed, the “Bi-Carbon 2%” brake pad has the lowest mass loss compared to the “Mono-Carbon” brake pad.

It follows that the presence of the second carbonaceous material, having a D₅₀ less than 10 μm and comprised within the inventive “Bi-Carbon 2%” brake pad, acts on the heat developed during the braking application that, instead of being accumulated in the brake pad destroying the binder, is dissipated.

### Particle Emission Test

The lost mass in the wear tests have been collected by suction at the test bench and have subsequently been analyzed in terms of particles number, amount of particulate matter (PM) and dispersion ratio (given by the particles number over the amount of PM). The first quantity has been obtained by means of Dekati® High Resolution ELPI® instrumentation, which gives real-time particle number size distribution in up to 500 size classes ranging from 6 nm to 10 μm.

The PM and PN is measured during the AKM test.

The amount of PM (in g) has been obtained by means of Dekati® eFilter™ instrumentation, which combines a standard gravimetric filter holder and sensitive real-time PM detection.

Particle emission test results are reported in Table 2.

TABLE 2

| | “Bi-Carbon 2%” | “Mono-Carbon” |
|---|---|---|
| Particles number (#) | 3.9 × 10¹³ | 6.7 × 10¹³ |
| Particulate matter (mg) | 5.2 | 1.0 × 10¹ |
| Dispersion ratio (#/mg) | 4.2 × 10¹² | 6.4 × 10¹² |

Notably, the lost mass by the “Bi-Carbon 28” brake pad contains a lower number of harmful particles, ranging from ultrafine particles of nanoscale size to coarse particles with a diameter of 10 μm, than the one emitted by the comparative “Mono-Carbon” brake pad. At the same time, the amount of the particulate matter emitted by the “Bi-Carbon 2%” brake pad during brake testing is lower than the one emitted by the comparative “Mono-Carbon” brake pad.

### Efficiency Test

The efficiency tests are carried out according to AK-Master standards

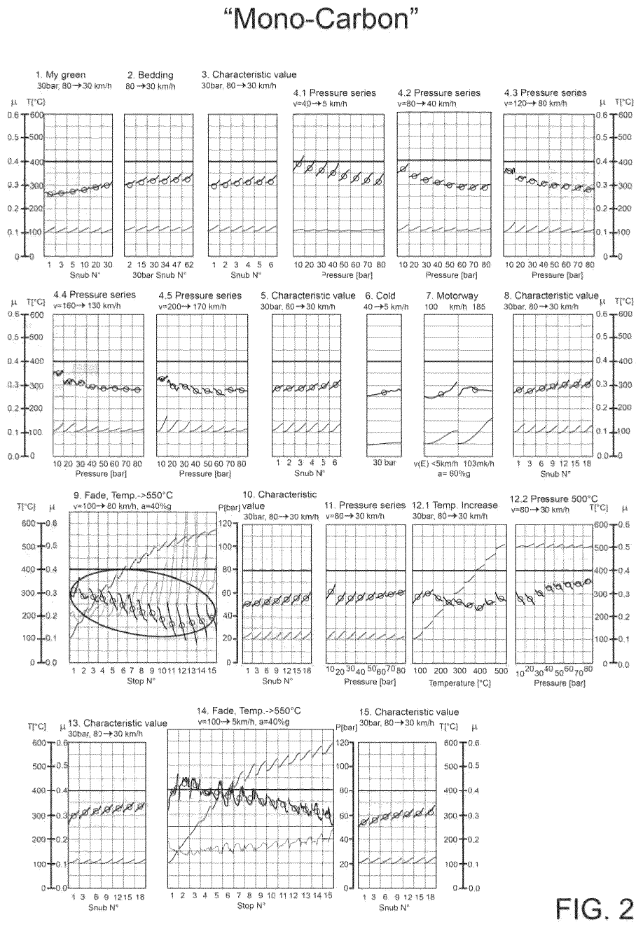

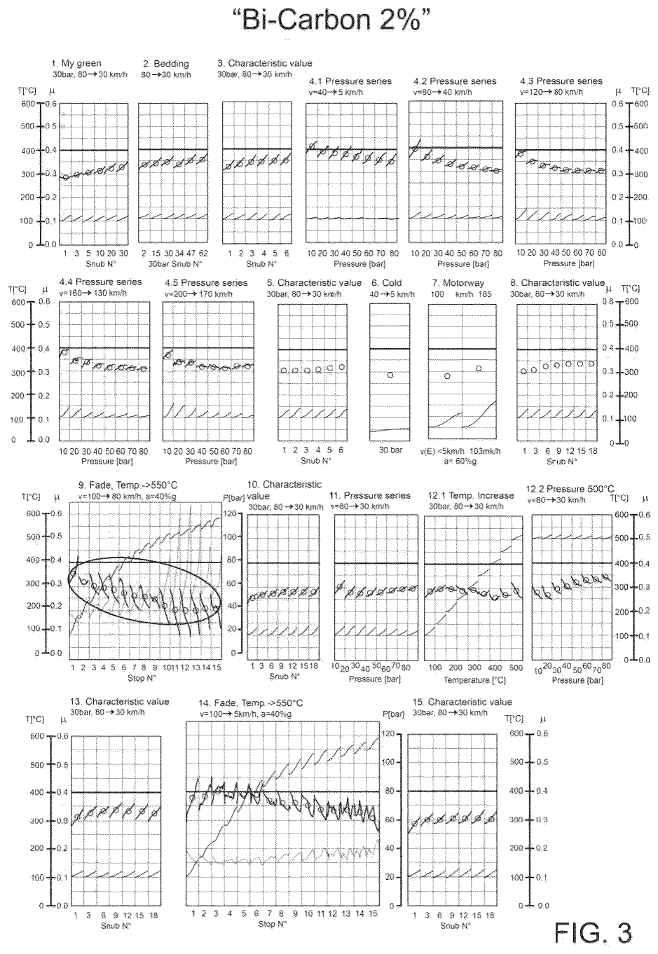

FIGS. 2 and 3 illustrate the typical reports of the results obtained from the AK-Master standard, presenting the different steps and cycles for “Mono-Carbon” (FIG. 2) and “Bi-Carbon 2%” (FIG. 3) brake pads, and showing the key variables such as friction (μ), pressure and temperature.

With specific reference to the FADE section at the 9^{th} step of the AK-Master standard test, it consists of 15 consecutive brake applications with fixed deceleration, initial and final speed. Specifically,
deceleration constant: 4 m/s²,
initial speed: 100 km/h
final speed: 5 km/h
end of the test minimum temperature to be reached: 550° C.

Of particular significance is the part encircled of the graph related to the FADE section for the comparative “Mono-Carbon” brake pad (FIG. 2) and for the inventive “Bi-Carbon 2%” brake pad (FIG. 3). The “Bi-Carbon 2%” brake pad, according to the invention, shows an overall nominal friction level comparable to the comparative “Mono-Carbon” brake pad; but the Fading performances of the “Bi-Carbon 2%” brake pad are slightly more stable along all the fade sections than those of the comparative “Mono-Carbon” brake pad.

### EXAMPLE 3

### Evaluation of Creep Groan Noise Using Laboratory-Scaled Tribometer

The ometer, used for testing the creep groan noise, is equipped with a climatic chamber for humidity evaluation and has the following specifications:
rotor speed: 0,1-5000 rpm
Torque: 0,01-5 Nm
Maximum load force: 2000 N

The tribometer samples are made of 10×10 mm of the friction material under investigation and cast iron discs. For each friction material, new disc has been used for measure at tribometer.

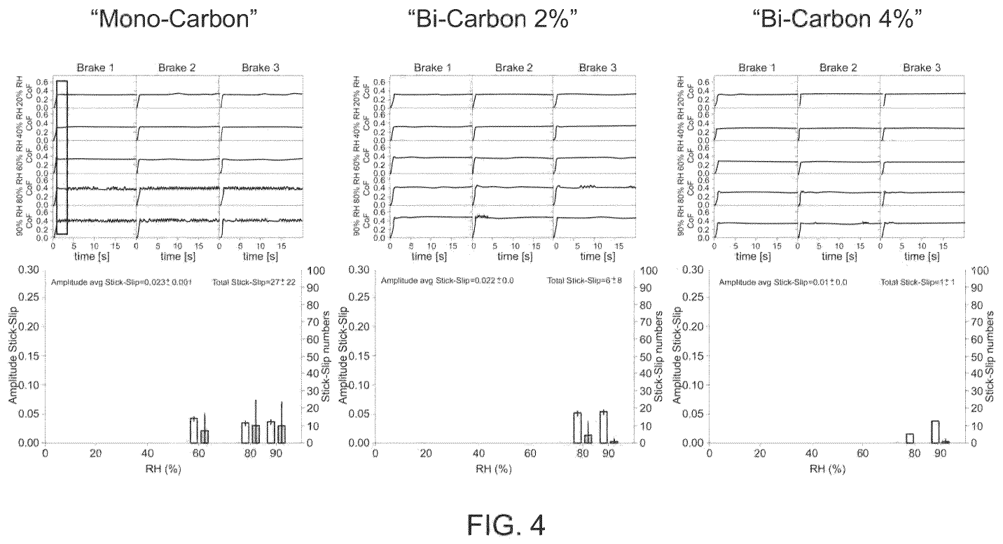

FIG. 4 shows the variation of the friction coefficient of the three friction materials (“Mono-Carbon”, “Bi-Carbon 2%” and “Bi-Carbon 4%”) in function of the time subjected to a normal force of 200 N at a disc rotation of 2 rpm, for several relative humidity (20% RH, 40% RH, 60% RH, 80% RH and 90% RH). Each test is repeated three times (Brake 1 Brake 2 and Brake 3).

From the non-resonance vibrations of the friction coefficient defining the so-called “discontinuous creep groan” zone (i.e. the zone of the graph enclosed in the rectangle), it is possible to calculate the number of the stick-slip phenomena per test as well as the stick-slip amplitude. Specifically, the stick-slip amplitude is calculated as the mean of the difference between static and dynamic coefficient of friction,

FIG. 4 shows the amplitude stick-slip and stick-slip numbers in function of humidity for the three friction materials. The amplitude stick-slip and stick-slip numbers result from the sum of the three tests (Brake 1, Brake 2 and Brake 3) and the error is the standard deviation of the three

Notably, “Bi-Carbon 4%” friction material, followed by the “Bi-Carbon 2%” friction material, reduces the occurrence of the stick-slip phenomena in terms of amplitude and frequency with respect to the comparative “Mono-Carbon” brake pad.

It is thus clear that the “Bi-Carbon 4%” and “Bi-Carbon 2% ” brake pads, according to the invention, have a dramatically lower creep groan noise propensity than the comparative “Mono-Carbon” brake pad.

### EXAMPLE 4

### Porosity of the Friction Material According to the Invention

Mercury porosimetry has been applied to characterize the porosity of the three friction materials under investigation in terms of open porosity, dimension of pore and their distribution.

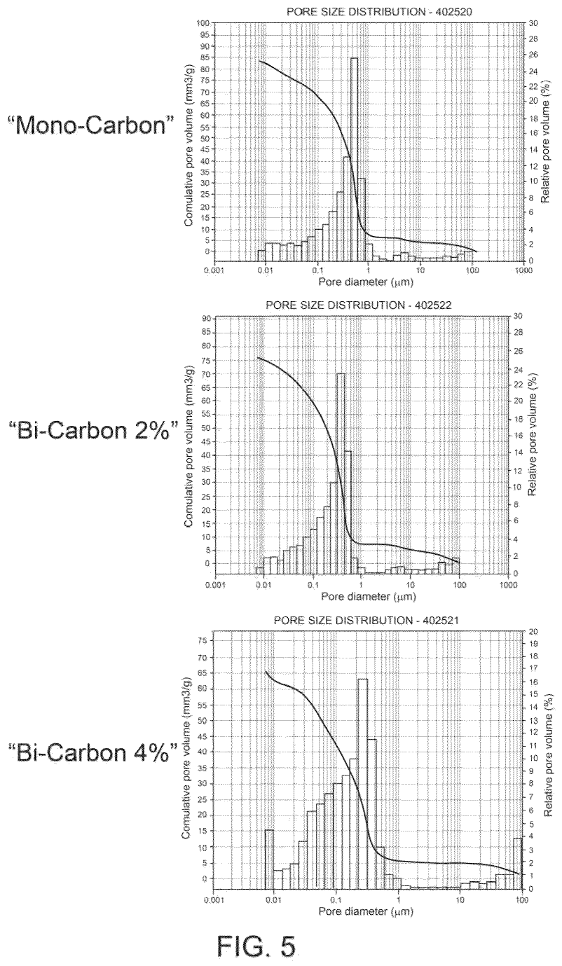

The results are shown in FIG. 5 and summarized in Table 3.

TABLE 3

| | “Bi-Carbon | “Bi-Carbon | |
|---|---|---|---|
| | 2%” | 4%” | “Mono-Carbon” |
| Open porosity [*] | 18 | 15 | 20 |
| Median pore size | 0.3205 | 0.1752 | 0.4067 |
| (μm) | | | |

Notably, the porosity of the “Bi-Carbon 4%” friction material, followed by the “Bi-Carbon 2%” friction material, according to the invention is lower than the porosity of the comparative “Mono-Carbon” friction material.

The same trend also applies for the average pore size. Indeed, the “Bi-Carbon 4%” friction material, according to the invention, has the lowest average pore size followed by the “Bi-Carbon 2%” friction material.

It is, thus, clear that the ultra-fine second carbonaceous material, only present in the friction materials according to the invention, surprisingly contributes to reducing the porosity of the friction material.

Due to the lower porosity, the friction material according to invention results to be less sensitive to the relative humidity and thus the stick-slip phenomena are less negatively affected by the humidity.

At the same time, the lower average pore size of the friction material according to the invention leads to a better adhesion between the friction material surface and the disc surface, thus further reducing the occurrence of the stick-slip behavior.

From the above working examples and disclosure it is clear that the friction material compositions prepared according to this disclosure have low creep groan noise propensity thanks to the reduced stick-slip phenomena; low particles emission, which is directly linked to reduced material wear, and an improved friction stability with respect to the comparative compositions.

All the aims of the present disclosure therefore fulfilled.

### Certain Terminology

Although certain braking devices, systems, and methods have been disclosed in the context of certain example embodiments, it will be understood by those skilled in the art that the scope of this disclosure extends beyond the specifically disclosed embodiments to other alternative embodiments and/or uses of the embodiments and certain modifications and equivalents thereof, like brake shows for braking systems based on brake drums. Use with any structure is expressly within the scope of this invention. Various features and aspects of the disclosed embodiments can be combined with or substituted for one another in order to form varying modes of the assembly. The scope of this disclosure should not be limited by the particular disclosed embodiments described herein.

Conditional language, such as “can,” “could,” “might,” “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Unless stated otherwise, the terms approximately, “about,” and “substantially” as used herein represent an amount close to the stated amount that still performs desired function or achieves a desired result. For example, in some embodiments, as the context may dictate, the terms “approximately”, “about”, and “substantially” may refer to an amount that is within less than or equal to 10% of the stated amount. Likewise, the term “generally” as used herein represents a value, amount, or characteristic that predominantly includes or tends toward a particular value, amount, or characteristic,

This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

1. An asbestos free friction material composition comprising:
at least one filler;
at least a fibrous material selected from the group consisting of inorganic fibers, organic fibers, metallic fibers and any combination thereof;
at least one binder;
at least one lubricant;
at least one or more abrasives; and
at least a first and at least a second carbonaceous material, wherein
the first carbonaceous material has a particle size distribution such as to have a D50 higher than 10 μm, and
the second carbonaceous material has a particle size distribution such as to have a D50 less than 10 μm.

2. The asbestos free friction material composition according to claim 1, wherein the at least first carbonaceous material having a D50 higher than 10 μm is present in the composition in an amount ranging from 2 to 6% in weight calculated on the total weight of the friction material composition.

3. The asbestos free friction material composition according to claim 1, wherein the at least second carbonaceous material having a D50 less than 10 μm is present in the composition in an amount ranging from 1 to 4% in weight calculated on the total weight of the friction material composition.

4. The asbestos free friction material composition according to claim 1, wherein the composition ratio between the first and the second carbonaceous material ranges from 1:1 to 6:1 and preferably from 2:1 to 3:1.

5. The asbestos free friction material composition according to claim 1, wherein the at least first carbonaceous material having a D50 higher than 10 μm is selected from the group consisting of graphite, petroleum coke, desiccated petroleum coke, carbon black and any mixtures thereof.

6. The asbestos free friction material composition according to claim 5, wherein the at least first carbonaceous material having a D50 higher than 10 μm is graphite.

7. The asbestos free friction material composition according to claim 1, wherein the at least second carbonaceous material having a D50 less than 10 μm is selected among the fillers consisting in a carbon black.

8. The asbestos free friction material composition according to claim 1, wherein the at least one fibrous material consists in organic fibers selected from the group consisting of polyacrylic fibers, polyaramid fibers, aramid fibers, cellulose fibers, any mixture thereof; and/or of inorganic or metallic fibers.

9. The asbestos free friction material composition according to claim 1, wherein the at least one lubricant consists of a sulphide based lubricant selected from the group consisting of the metal sulfides of Sn, Zn, Fe, Mo, and mixtures thereof.

10. The asbestos free friction material composition according to claim 1, wherein the at least one or more abrasives comprises at least one soft abrasive having a Mohs hardness of below 7 and selected from the group consisting of magnesia, cromite, magnetite, hematite, quartz, zinc oxides, tin oxides, barium sulphate, silicate, fluoride and any mixture thereof.

11. The asbestos free friction material composition according to claim 1, wherein the at least one or more abrasive comprises at least one hard abrasive having a Mohs hardness of above 7 and preferably having a roundish-shape, the hard abrasive being selected from the group consisting of zirconia, alumina, corundum, silicon carbide, tungsten carbide, zirconium carbide, zirconium silicate, boron nitride and any mixture thereof.

12. The asbestos free friction material composition according to claim 11, wherein the composition ratio between the soft abrasive and hard abrasive ranges from 1:1 to 4:1.

13. The asbestos free friction material composition according to claim 1, wherein the asbestos free friction material composition is free of copper and of any copper alloy.

14. The asbestos free friction material composition according to claim 1, wherein the asbestos free friction material composition comprises at least one metal except than copper and copper alloys selected from the group consisting of iron, steel, stainless steel, tin, zinc and any alloys thereof in powder or fiber form.

15. The asbestos free friction material composition according to claim 1, wherein the at least one filler is an inorganic filler selected from the group consisting of mineral fibers, glass fibers, rockwool, phillosilicates (mica, vermiculite, talc), Titanates, inorganic hydroxides of Ca, Mg, K and any mixture thereof.

16. The asbestos free friction material composition according to claim 1, wherein the asbestos free friction material composition comprises the following components in weight percentage calculated on the total weight of the friction material composition:

| | |
|---|---|
| ABRASIVE MOHS > 7 | 15-35 |
| ABRASIVE MOHS < 7 | 30-60 |
| RESIN | 6-10 |
| ORGANIC ADDITIVES | 4-8 |
| ORGANIC FIBER | 2-4 |
| LUBRICANTS | 2-8 |
| FIRST CARBONACEOUS COMPONENT | 2-6 |
| SECOND CARBONACEOUS COMPONENT | 1-4 |

17. A friction element having a friction layer made with a friction material composition, the friction material composition comprising:
at least one filler;
at least a fibrous material selected from the group consisting of inorganic fibers, organic fibers, metallic fibers and any combination thereof;
at least one binder;
at least one lubricant;
at least one or more abrasives; and
at least a first and at least a second carbonaceous material, wherein
the first carbonaceous material has a particle size distribution such as to have a D50 higher than 10 μm, and
the second carbonaceous material has a particle size distribution such as to have a D50 less than 10 μm.

18. The friction element according to claim 17, the friction element is a brake pad or a brake shoe.

19. A braking system comprising:
a member to be braked, constituted by a brake disc or brake drum made of cast iron or steel; and
at least one braking member constituted by a brake pad or brake shoe, adapted to cooperate by friction with the member to be braked, wherein the braking member has a friction layer intended to cooperate with the member to be braked made of a friction material composition, the friction material composition comprising:
at least one filler;
at least a fibrous material selected from the group consisting of inorganic fibers, organic fibers, metallic fibers and any combination thereof;
at least one binder:
at least one lubricant:
at least one or more abrasives: and
at least a first and at least a second carbonaceous material, wherein
the first carbonaceous material has a particle size distribution such as to have a D50 higher than 10 μm, and
the second carbonaceous material has a particle size distribution such as to have a D50 less than 10 μm.
